(19) United States
(12) Patent Application Publication
(10) Pub. No.: US 2021/0110043 A1
(43) Pub. Date: Apr. 15, 2021

(54) PLATFORM FIRMWARE BOOT MECHANISM

(71) Applicant: Intel Corporation, Santa Clara, CA (US)

(72) Inventors: Michael Berger, Jerusalem (IL); Anoop Mukker, Folsom, CA (US); Karunakara Kotary, Portland, OR (US); Nivedita Aggarwal, Portland, OR (US); Udy Hershkovitz, Jerusalem (IL); Arijit Chattopadhyay, Folsom, CA (US); Jabeena B. Gaibusab, Bangalore (IN); Christopher J. Lake, Folsom, CA (US)

(73) Assignee: Intel Corporation, Santa Clara, CA (US)

(21) Appl. No.: 17/132,188

(22) Filed: Dec. 23, 2020

(51) Int. Cl. G06F 21/57; G06F 21/55; G06F 21/79; G06F 21/31; G06F 12/1081

(52) U.S. Cl. CPC G06F 21/575; G06F 21/554; G06F 12/1081; G06F 21/31; G06F 21/79

(57) ABSTRACT

An apparatus to facilitate a computer system platform boot is disclosed. The apparatus comprises a system on chip (SOC), including a cache memory, a storage device to store platform firmware including boot code, a security controller to load the boot code into the cache during a platform reset and a processor to execute the boot code from the cache memory to initiate the SOC.

### BACKGROUND OF THE DESCRIPTION

A system on chip (SOC) is an integrated circuit that integrates all components of a computer or other electronic system. These components include a central processing unit (CPU), memory, input/output (IO) ports and secondary storage, which are all included on a single substrate or microchip. Additionally, SOCs enable the integration of third party components via a standardized on-die interconnect protocol. However, the addition of such components may lead to security vulnerabilities.

### BRIEF DESCRIPTION OF THE DRAWINGS

So that the manner in which the above recited features of the present embodiment can be understood in detail, a more particular description of the embodiment, briefly summarized above, may be had by reference to embodiments, some of which are illustrated in the appended drawings. It is to be noted, however, that the appended drawings illustrate only typical embodiments of this embodiment and are therefore not to be considered limiting of its scope, for the embodiment may admit to other equally effective embodiments.

FIG. 1 illustrates one embodiment of a computing device.

FIGS. 2A-2C illustrate embodiments of a platform.

FIG. 3 illustrates yet another embodiment of a platform.

FIG. 4 illustrates one embodiment of a security controller.

FIG. 5A illustrates one embodiment of a storage device.

FIG. 5B illustrates one embodiment of a memory map.

FIG. 6 is a flow diagram illustrating one embodiment of a boot process.

FIG. 7 illustrates one embodiment of a schematic diagram of an illustrative electronic computing device.

### DETAILED DESCRIPTION

In the following description, numerous specific details are set forth to provide a more thorough understanding of the present embodiment. However, it will be apparent to one of skill in the art that the present embodiment may be practiced without one or more of these specific details. In other instances, well-known features have not been described in order to avoid obscuring the present embodiment.

In embodiments, a mechanism is provided to facilitate a computer system platform boot. In such embodiments, a system on chip (SOC) includes a storage device that stores a boot firmware image, which is copied to cache during a system start up. Subsequently, a processor executes the boot code stored in the boot firmware image to boot the SOC from the cache.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

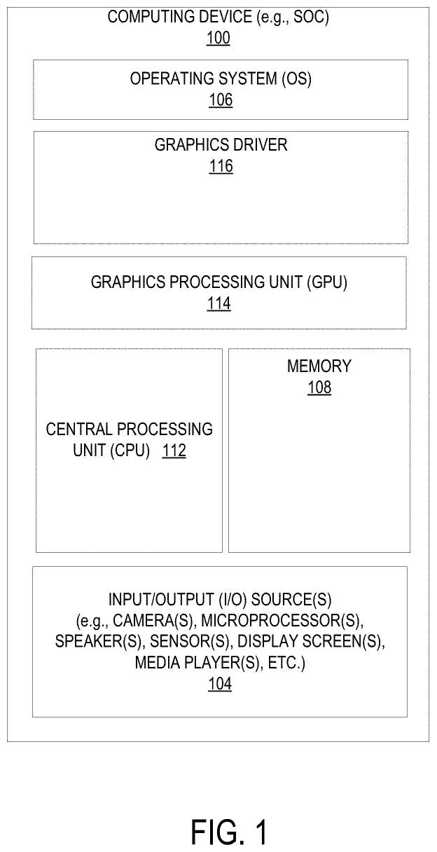

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

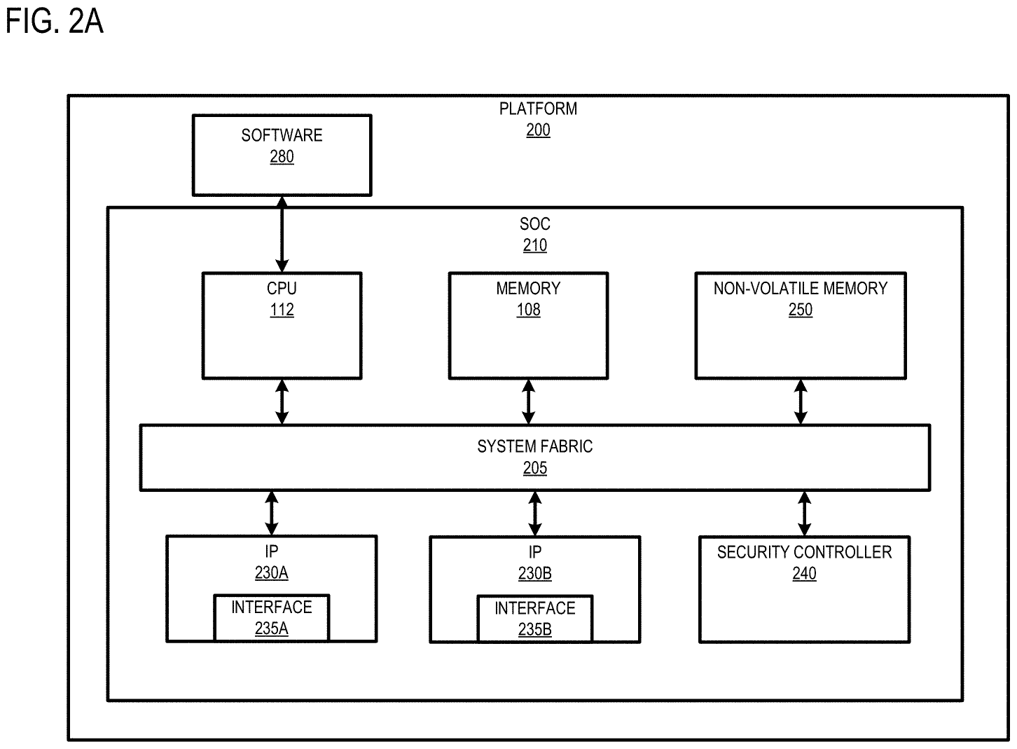

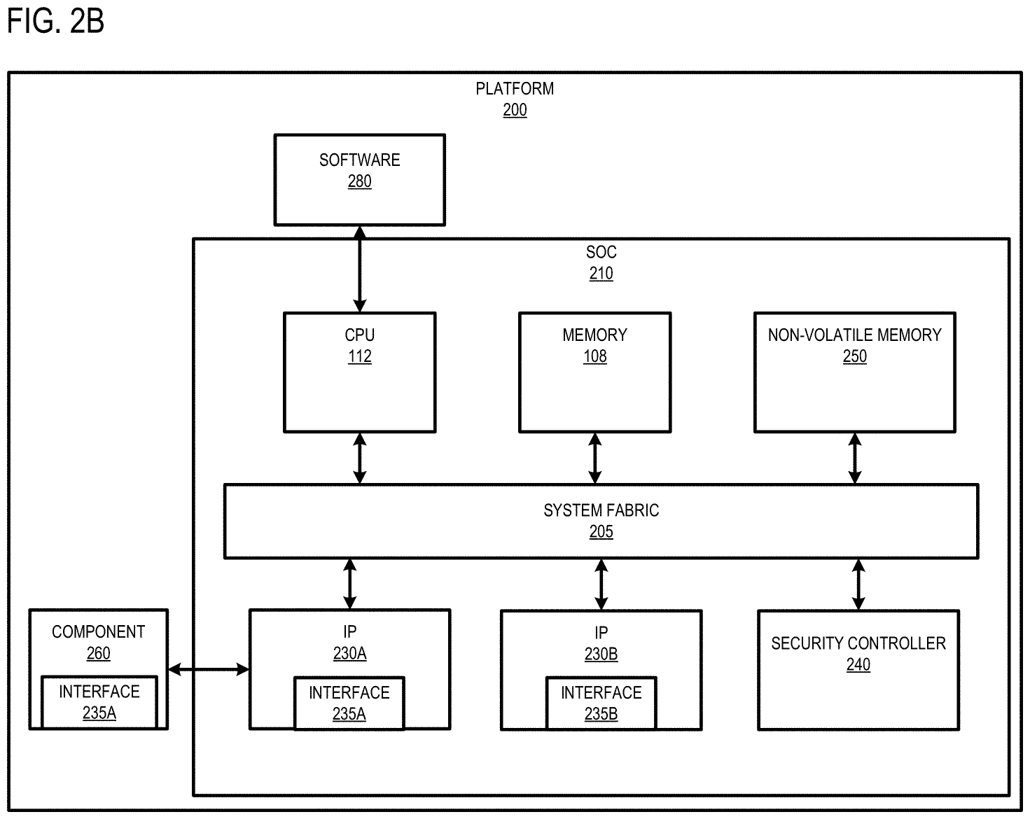

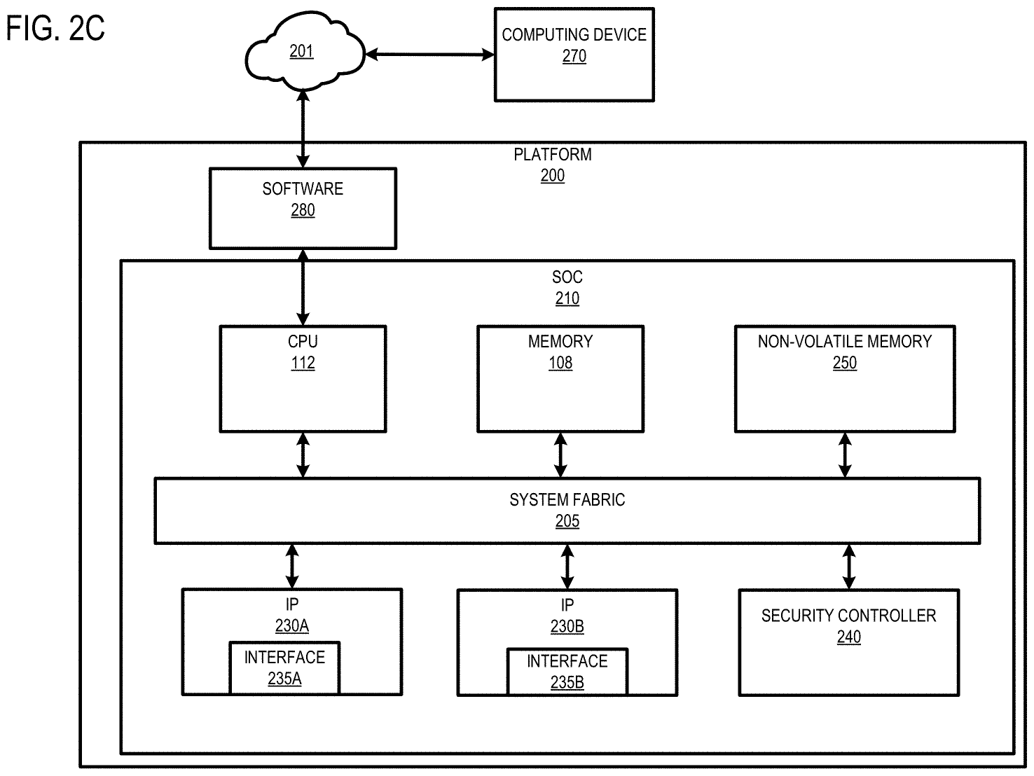

FIGS. 2A-2C illustrate embodiments of a platform 200 including a SOC 210 similar to computing device 100 discussed above. As shown in FIG. 2A, platform 200 includes SOC 210 communicatively coupled to one or more software components 280 via CPU 112. Additionally, SOC 210 includes other computing device components (e.g., memory 108) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP agents 230A and 230B) within SOC 210. In such an embodiment, the interconnect protocol provides a standardized interface to enable third parties to design logic such as IP agents to be incorporated in SOC 210.

According to embodiment, IP agents 230 may include general purpose processors (e.g., in-order or out-of-order cores), fixed function units, graphics processors, I/O controllers, display controllers, etc. In such an embodiment, each IP agent 230 includes a hardware interface 235 (e.g., interfaces 235A and 235B) to provide standardization to enable the IP agent 230 to communicate with SOC 210 components. For example, in an embodiment in which IP agent 230 is a third party visual processing unit (VPU), interface 235 provides a standardization to enable the VPU to access memory 108 via fabric 205.

SOC 210 also includes a security controller 240 that operates as a security engine to perform various security operations (e.g., security processing, cryptographic functions, etc.) for SOC 210. In one embodiment, security controller 240 comprises an IP agent 230 that is implemented to perform the security operations. Further, SOC 210 includes a non-volatile memory 250. Non-volatile memory 250 may be implemented as a Peripheral Component Interconnect Express (PCIe) storage drive, such as a solid state drives (SSD) or Non-Volatile Memory Express (NVMe) drives. In one embodiment, non-volatile memory 250 is implemented to store the platform 200 firmware. For example, non-volatile memory 250 stores boot (e.g., Basic Input/Output System (BIOS)) and device (e.g., IP agent 230 and security controller 240) firmware.

FIG. 2B illustrates another embodiment of platform 200 including a computing device 270 coupled to SOC 210 via IP agent 230A. In one embodiment, IP agent 230A operates as a bridge, such as a PCIe root port, that connects component 260 to SOC 210. In this embodiment, component 260 may be implemented as a PCIe device (e.g., switch or endpoint) that includes a hardware interface 235 to enable component 260 to communicate with SOC 210 components. FIG. 2C illustrates yet another embodiment of platform 200 including a computing device 270 coupled to platform 200 via a cloud network 201. In this embodiment, computing device 270 comprises a cloud agent that is provided access to SOC 210 via software 280.

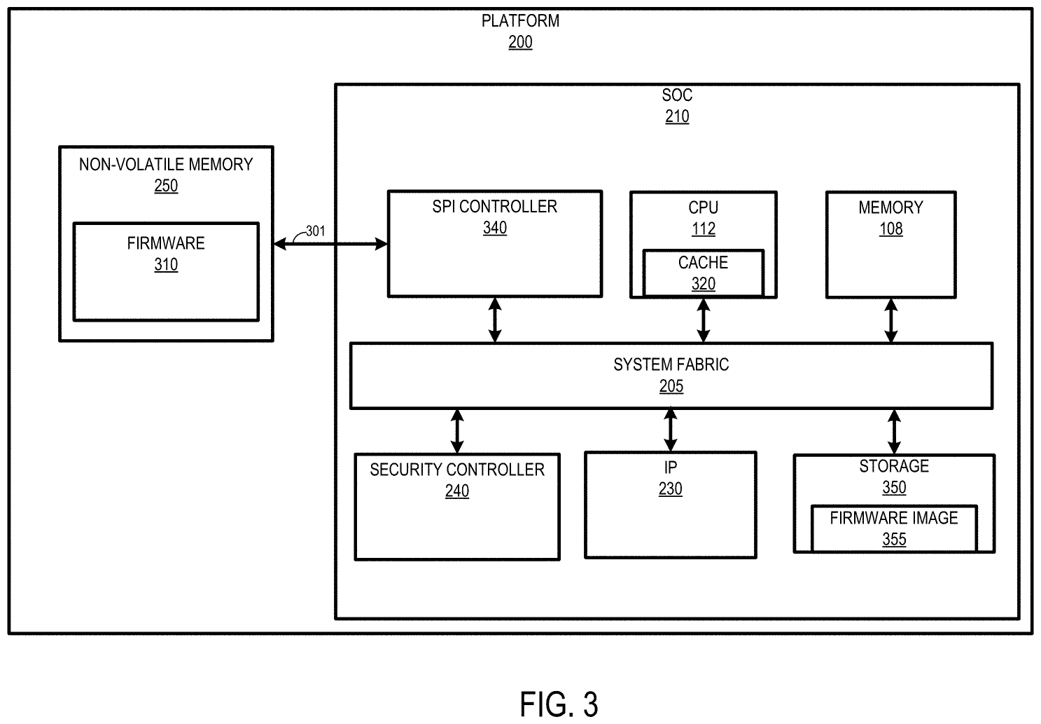

FIG. 3 illustrates still another embodiment of platform 200 including non-volatile memory 250 coupled to SOC 210 via a serial peripheral interface (SPI) 301. As mentioned above, non-volatile memory 250 is implemented as a storage for platform firmware 310. In one embodiment, resiliency support is provided for firmware stored in non-volatile memory 250. SPI controller 340 is also coupled to system fabric 205. In one embodiment, SPI controller 340 is a flash controller implemented to control access to non-volatile memory 250 via SPI 301. In a further embodiment, SPI controller 340 facilitates the updating of firmware 310.

Typically, firmware 310 is accessed by SOC 210 to retrieve boot code in order to perform a platform boot. However, in some instances, non-volatile memory 250 may not be accessible to SOC 210. According to one embodiment, SOC 210 may be configured to perform a platform boot without accessing firmware 310. In such an embodiment, SOC 210 includes a storage device 350 that stores platform firmware 355 that is loaded by security controller 240 into a cache memory (or cache) 320 (e.g., within CPU 112) to enable a secure boot from SOC 210. In a further embodiment, CPU 112 sets up cache 320 in a flat memory mode (or flat mode) to enable security controller 240 to initiate a direct memory access (DMA) transfer of the boot firmware from storage device 350 to cache 320. In yet a further embodiment, security controller 240 facilitates execution of the boot firmware from cache 320.

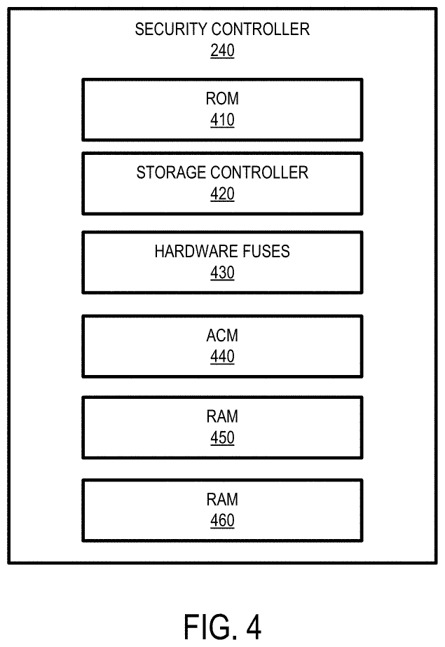

FIG. 4 illustrates one embodiment of security controller 240. As shown in FIG. 4, security controller 240 includes a read only memory (ROM) 410, storage controller 420, hardware fuses 430, Authenticate Code Module (ACM) 440 random access memory (RAM) 450 and engine 460. In one embodiment, ROM 410 is implemented to activate security controller 240 upon a platform reset. In a further embodiment, ROM 410 includes a storage driver and protocol stack which enables security controller 240 to control access to storage device 350 via storage controller 420 once activated. In still a further embodiment, ROM 410 includes 360 firmware that is implemented to control security controller 240 operations.

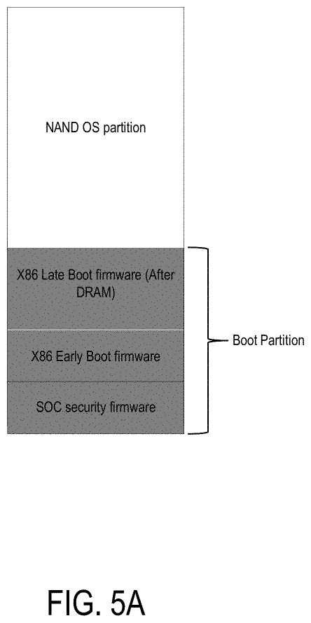

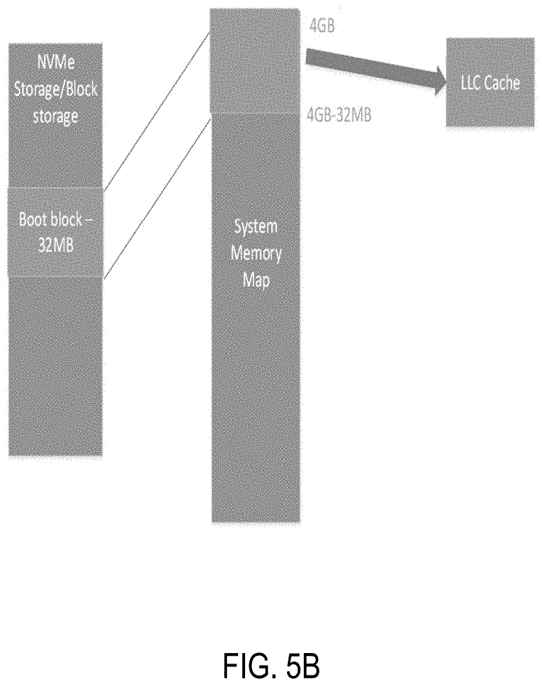

Hardware fuses 430 are accessed by CPU 112 during reset to set up cache 320 in the flat memory mode. In flat memory mode, CPU 112 is configured to jump to a fixed address (e.g., a reset vector, such as 0xFFFFFFF0) upon coming out of reset. In one embodiment, CPU 112 points the boot reset vector to cache 320 (e.g., rather than firmware 310 in non-volatile memory 250). However, at this point there is no content in cache 320. Once the boot reset vector is set, security controller 240 performs a write to cache (WRC) DMA write to transfer firmware 355 in storage device 350 to cache 320. FIG. 5A illustrates one embodiment of a storage device 350. As shown in FIG. 5A, storage device 350 includes an OS partition and a boot partition including boot firmware. FIG. 5B illustrates one embodiment of an emulated memory copy being used to DMA data from storage device 350 to cache 320, which is mapped to RAM 450.

Once stored in cache 320, security controller 240 verifies the integrity of firmware 355 (e.g., via a cryptographic hash) and writes ACM 440 into cache 320. In one embodiment, ACM 440 is implemented to authenticate BIOS firmware in cache 320. As part of a secure boot, all firmware in the boot path must be verified prior to being executed. Thus, ACM 440 is verified by security controller 240 to establish a chain of trust. ACM 440 is executed by CPU 112 and is implemented to perform verification in a trusted manner as firmware is located in a location trusted by CPU 112.

During the firmware verification, security controller 240 copies its own firmware into memory 108, verifies the contents before uploading the contents into engine 460. Once ACM 440 is verified and executed, an initial boot block (IBB) included in firmware 355 is loaded into cache 320 and is verified by ACM 440. Subsequently, the IBB is executed by CPU 112 initializes the rest of SOC 210 and installs storage drivers. At this point, the IBB controls (or owns) storage device 350.

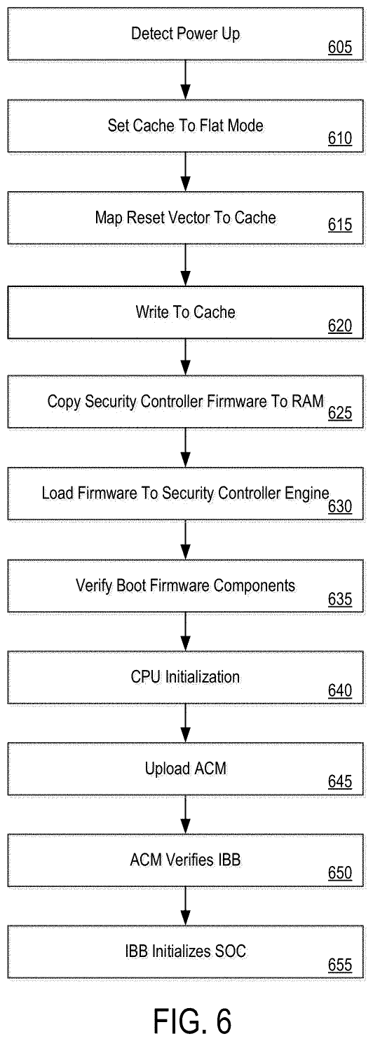

FIG. 6 is a flow diagram illustrating one embodiment of a boot process. At processing block 605, an SOC power up is detected. At processing block 610, the CPU sets cache in flat mode (e.g., based on configuration fuses). At processing block 615, the CPU maps reset vector to cache. At processing block 620, the security controller performs a write to cache (e.g., via DMA) of boot firmware from the storage device to cache. At processing block 625, the security controller copies its own firmware into its memory and verifies the firmware. At processing block 630, the security controller loads the firmware into its engine.

At processing block 635, the security controller verifies the boot firmware in cache. At processing block 640, the CPU is initialized. In such an embodiment, internally sets the firmware interface table (FIT)/reset vector and internally maps the address to the cache. Additionally, the CPU loads the FIT into its internal ROM and loads FIT based patches from the cache. At processing block 645, the CPU uploads the ACM from cache. At processing block 650, the ACM verifies the IBB. At processing block 655, the IBB initializes the SOC. In embodiments, the IBB completes memory initialization, loads storage drivers and brings up the rest of BIOS.

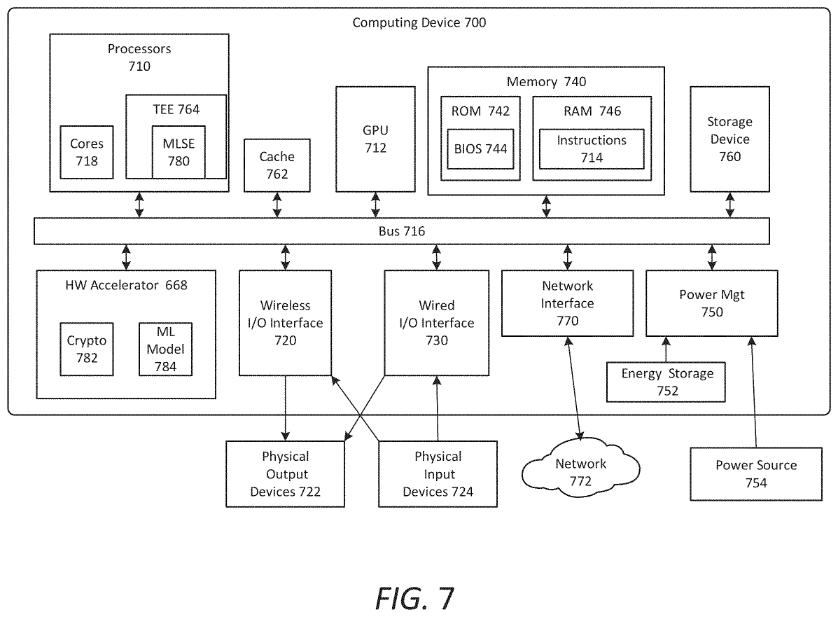

FIG. 7 is a schematic diagram of an illustrative electronic computing device to enable enhanced protection against adversarial attacks according to some embodiments. In some embodiments, the computing device 700 includes one or more processors 710 including one or more processors cores 718 and a TEE 764, the TEE including a machine learning service enclave (MLSE) 780. In some embodiments, the computing device 700 includes a hardware accelerator 768, the hardware accelerator including a cryptographic engine 782 and a machine learning model 784. In some embodiments, the computing device is to provide enhanced protections against ML adversarial attacks, as provided in FIGS. 1-6.

The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include, but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus to facilitate a computer system platform boot, comprising a system on chip (SOC), including a cache memory, a storage device to store platform firmware including boot code, a security controller to load the boot code into the cache during a platform reset and a processor to execute the boot code from the cache memory to initiate the SOC.

Example 2 includes the subject matter of Example 1, wherein the processor the processor sets up the cache memory in a flat memory mode and points a boot reset vector to the cache memory.

Example 3 includes the subject matter of Examples 1 and 2, wherein the processor maps a reset vector to the cache memory.

Example 4 includes the subject matter of Examples 1-3, further comprising a hardware fuse accessed by the processor to set up the cache memory in the flat memory mode.

Example 5 includes the subject matter of Examples 1-4, wherein the security controller performs a direct memory access (DMA) write to cache transfer to transfer the firmware from the storage device to the cache memory.

Example 6 includes the subject matter of Examples 1-5, wherein the security controller writes an Authenticate Code Module (ACM) to the cache memory.

Example 7 includes the subject matter of Examples 1-6, wherein the ACM verifies the boot code.

Example 8 includes the subject matter of Examples 1-7, wherein the security controller comprises a read only memory (ROM) to store security controller firmware, a random access memory (RAM) and an engine.

Example 9 includes the subject matter of Examples 1-8, wherein the security controller transfers the security controller firmware from the ROM to the RAM.

Example 10 includes the subject matter of Examples 1-9, wherein the security controller loads the security controller firmware into the engine from the RAM.

Some embodiments pertain to Example 11 that includes a method to facilitate a computer system platform boot, comprising detecting a computer system power up, setting up a cache memory in a flat memory mode, pointing a boot reset vector to the cache memory, transferring firmware from a storage device to the cache memory and executing the boot code included in the firmware from the cache memory to initiate the computer system platform.

Example 12 includes the subject matter of Example 11, further comprising mapping a reset vector to the cache memory.

Example 13 includes the subject matter of Examples 11 and 12, wherein setting up the cache memory in the flat memory mode comprises accessing a hardware fuse.

Example 14 includes the subject matter of Examples 11-13, wherein transferring the firmware from the storage device to the cache memory comprises performing a direct memory access (DMA) write to cache transfer.

Example 15 includes the subject matter of Examples 11-14, further comprising writing an Authenticate Code Module (ACM) to the cache memory.

Some embodiments pertain to Example 16 that includes a further comprising the ACM verifying the boot code.

Example 17 includes the subject matter of Example 16, at least one computer readable medium having instructions stored thereon, which when executed by one or more processors, cause the processors to detect a computer system power up, set up a cache memory in a flat memory mode, point a boot reset vector to the cache memory, transfer firmware from a storage device to the cache memory and execute the boot code included in the firmware from the cache memory to initiate the computer system platform.

Example 18 includes the subject matter of Examples 16 and 17, wherein setting up the cache memory in the flat memory mode comprises accessing a hardware fuse.

Example 19 includes the subject matter of Examples 16-18, wherein transferring the firmware from the storage device to the cache memory comprises performing a direct memory access (DMA) write to cache transfer.

Example 20 includes the subject matter of Examples 16-19, having instructions stored thereon, which when executed by one or more processors, further cause the processors to write an Authenticate Code Module (ACM) to the cache memory and verify the boot code using the ACM.

The embodiments have been described above with reference to specific embodiments. Persons skilled in the art, however, will understand that various modifications and changes may be made thereto without departing from the broader spirit and scope of the embodiment as set forth in the appended claims. The foregoing description and drawings are, accordingly, to be regarded in an illustrative rather than a restrictive sense.

What is claimed is:

1. An apparatus comprising:
a system on chip (SOC), including:
a cache memory;
a storage device to store platform firmware including boot code;
a security controller to load the boot code into the cache during a platform reset; and
a processor to execute the boot code from the cache memory to initiate the SOC.

2. The apparatus of claim 1, wherein the processor the processor sets up the cache memory in a flat memory mode and points a boot reset vector to the cache memory.

3. The apparatus of claim 1, wherein the processor maps the boot reset vector to the cache memory.

4. The apparatus of claim 3, further comprising a hardware fuse accessed by the processor to set up the cache memory in the flat memory mode.

5. The apparatus of claim 3, wherein the security controller performs a direct memory access (DMA) write to cache transfer to transfer the firmware from the storage device to the cache memory.

6. The apparatus of claim 5, wherein the security controller writes an Authenticate Code Module (ACM) to the cache memory.

7. The apparatus of claim 6, wherein the ACM verifies the boot code.

8. The apparatus of claim 6, wherein the security controller comprises:
a read only memory (ROM) to store security controller firmware;
a random access memory (RAM); and
an engine.

9. The apparatus of claim 8, wherein the security controller transfers the security controller firmware from the ROM to the RAM.

10. The apparatus of claim 9, wherein the security controller loads the security controller firmware into the engine from the RAM.

11. A method comprising:
detecting a computer system power up;
setting up a cache memory in a flat memory mode;
pointing a boot reset vector to the cache memory;
transferring firmware from a storage device to the cache memory; and
executing boot code included in the firmware from the cache memory to initiate the computer system platform.

12. The method of claim 11, further comprising mapping a reset vector to the cache memory.

13. The method of claim 12, wherein setting up the cache memory in the flat memory mode comprises accessing a hardware fuse.

14. The method of claim 13, wherein transferring the firmware from the storage device to the cache memory comprises performing a direct memory access (DMA) write to cache transfer.

15. The method of claim 14, further comprising writing an Authenticate Code Module (ACM) to the cache memory.

16. The method of claim 15, further comprising the ACM verifying the boot code.

17. At least one computer readable medium having instructions stored thereon, which when executed by one or more processors, cause the processors to:
detect a computer system power up;
set up a cache memory in a flat memory mode;
point a boot reset vector to the cache memory;
transfer firmware from a storage device to the cache memory; and
execute boot code included in the firmware from the cache memory to initiate a computer system platform.

18. The computer readable medium of claim 17, wherein setting up the cache memory in the flat memory mode comprises accessing a hardware fuse.

19. The computer readable medium of claim 18, wherein transferring the firmware from the storage device to the cache memory comprises performing a direct memory access (DMA) write to cache transfer.

20. The computer readable medium of claim 19, having instructions stored thereon, which when executed by one or more processors, further cause the processors to:
write an Authenticate Code Module (ACM) to the cache memory; and
verify the boot code using the ACM.
